(19) United States
(12) Patent Application Publication
(10) Pub. No.: US 2003/0113064 A1
(43) Pub. Date: Jun. 19, 2003

(54) Inducing change of refractive index by differing radiations

(76) Inventors: Leon Poladian, Glebe, NSW (AU); Justin L Blows, Erskinville, NSW (AU); Graham R Atkins, Downer, ACT (AU)

Correspondence Address: LADAS & PARRY, 224 SOUTH MICHIGAN AVENUE, SUITE 1200, CHICAGO, IL, 60604, US

(21) Appl. No.: 10/182,883

(22) PCT Filed: Feb. 2, 2001
(86) PCT No.: PCT/AU01/00093

(30) Foreign Application Priority Data
Feb. 3, 2000 (AU) PQ 5424

(51) Int. Cl. G02B 6/34; G02B 6/00

(52) U.S. Cl. 385/37; 385/147; 385/141; 430/290

(57) ABSTRACT

The present invention provides a method of inducing a change in refractive index of a photosensitive material. The method comprises the step of simultaneously exposing a region of the material to first and second radiations having first and second wavelengths respectively and being selected, in combination, to induce the change in refractive index in the region, and wherein the first and second wavelengths differ from each other. In one embodiment, the region is a first core (42) of a multiple-core optical fibre (40). The first radiation (48) is propagated along the first core (42) and the second radiation (46) is used to illuminate the first core from outside the fibre (40) through a phase mask (52). This embodiment enables an optical grating to be written in the first core (42) without inducing refractive index changes in the closely-adjacent second core (44).

### FIELD OF THE INVENTION

The present invention relates broadly to a method for inducing photosensitive changes in a photosensitive material. The present invention will be described herein with reference to a method and device for writing grating structures in optical waveguides. However, it will be appreciated that the invention does have broader applications including producing waveguide structures in a photosensitive material.

### BACKGROUND OF THE INVENTION

Optical gratings in waveguides typically comprise regions of higher and lower refractive index formed in a light transmitting device. In photosensitive materials the regions of varying refractive index can be produced by inducing permanent refractive index changes as a result of photon absorption processes.

Each of the regions is exposed to radiation of a predetermined wavelength typically chosen to induce the permanent desired refractive index change by photon absorption processes.

One method of writing a grating in a photosensitive material utilises interference patterns created from a beam of the predetermined wavelength by passing it through a phase mask.

In the described technique, the beam passes through the photosensitive material with little loss of intensity and continues to induce the refractive index changes throughout the material, and may induce further changes in adjacent photosensitive materials. Thus, this technique provides a limited control over the location where a desired change does occur. This makes the technique unsuitable for writing complex structures in close proximity to each other, which limits the design of more compact optical devices.

### SUMMARY OF THE INVENTION

The present invention provides a method of inducing a change in refractive index of a photosensitive material. The method comprises the step of simultaneously exposing a region of the material to first and second radiations having first and second wavelengths respectively and being selected, in combination, to induce the change in refractive index in the region, wherein the first and second wavelengths differ from each other, and each of the first and second radiations alone being substantially ineffective in inducing a refractive index change in the region.

Accordingly, this method can provide increased control over the location of refractive index changes i.e. where the first and second radiations overlap.

Each of the first and second wavelengths may be selected to be ineffective alone in inducing a further change in the photosensitive material.

The region may comprise a light-guiding region of a waveguide formed in the photosensitive material. A first beam of the first radiation may be coupled into and guided along the light-guiding region. In one embodiment, it is only the first radiation which is propagated along the waveguide.

The second radiation may be in the form of a second beam arranged to illuminate the light-guiding region from outside the waveguide. The second radiation may illuminate the light-guiding region in a direction which is substantially transverse to the first beam.

The photosensitive material may include an outer plastics coating and the photosensitive material may be exposed to the second radiation through the outer plastics coating. The wavelength of the second radiation is preferably selected to pass through the plastics coating substantially without absorption. Thus, the present invention may be used to write an optical structure (such as a grating) in a coated fibre without needing to remove the coating.

The waveguide may comprise an optical fibre. In one embodiment, the waveguide comprises a multiple-core optical fibre, and the light-guiding region comprises a first core of the fibre. The first beam may be coupled into and guided along the first core so as to induce the refractive index change in the first core only. Thus, the invention may be used to induce refractive index changes in one core of a multiple-core fibre, without inducing any refractive index changes in a closely-adjacent second core of the same fibre. Equally, the invention can be used to write different optical structures in the closely-adjacent cores of a multiple-core fibre.

The first and second radiations may be provided from separate sources. Alternatively, the first and second radiations maybe provided by the same source.

The method may further comprise the steps of setting up an interference pattern with the first beam in the material, and exposing the material to the second beam to induce the refractive index change in the material where the interference pattern and the second beam overlap. The method can further comprise utilising a chosen intensity profile of the second beam to control the overlapping of the second beam with the interference pattern. Accordingly, in one embodiment, a profile of a grating may be apodised independent of the form of the interference pattern.

At least one of the first and second wavelengths may be chosen from a range of visible wavelengths. Accordingly, a pattern for writing e.g. a waveguide structure may be “visually” optimised before co-exposure to the second radiation.

Alternatively, at least one of the first and second wavelengths may be substantially 1550 nm. An advantage of this wavelength is that high-powered sources of 1550 nm light are readily available. Also, light of this wavelength can be readily coupled into a waveguide such as an optical fibre.

Where the method is to be applied to germanium-doped glass, combined photon energies of the first and second radiations may be selected to excite the 185 nm absorption band in the germanium-doped glass. Alternatively, the combined photon energies may be selected to excite the 244 nm absorption band in the germanium-doped glass. In yet another embodiment, the combined photon energies of the first and second radiation may be selected to excite the 325 nm absorption band in the germanium-doped glass.

The step of inducing the change in the region may comprise the absorption of the first and second radiations mediated by a real transition level of the photosensitive material. Where the photosensitive material comprises glass, the real transition level may be provided by doping the glass with lanthanide ions. The lanthanide ion may be Neodymium. Alternatively, the lanthanide ion may comprise Ytterbium. Alternatively, the lanthanide ion may comprise Thulium.

The invention may alternatively be defined as providing an optical device incorporating a photosensitive material in which a refractive index change has been induced in the photosensitive material using the method described above. Preferred forms of the invention will now be described, by way of example only, with reference to the accompanying drawings, in which:

### BRIEF DESCRIPTION OF THE DRAWINGS

FIG. 1 is a schematic drawing illustrating a method of writing a grating structure embodying the present invention.

FIG. 2 is a schematic drawing illustrating a comparison of excitation by different absorption processes embodying the present invention.

FIG. 3 is a schematic drawing illustrating a method of writing a device structure in a multi-core optical fibre embodying the present invention.

FIG. 4 is a schematic drawing illustrating a method of inducing a refractive index change embodying the present invention.

### DETAILED DESCRIPTION OF THE PREFERRED EMBODIMENTS

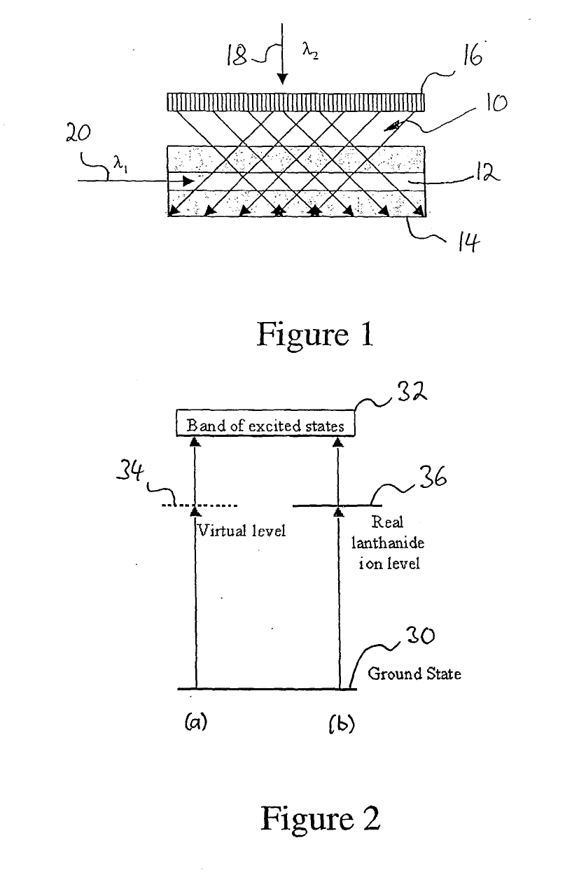

In FIG. 1, an interference pattern 10 is set up within a core 12 of an optical fibre 14 by using an external phase mask 16 with a first incoming beam 18 having wavelength λ₂.

A second beam 20 having wavelength λ₁ is launched into the core 12 of the fibre 14. Both the wavelength λ₁ and λ₂ are chosen such that each of the beams 18, 20 alone does not induce a refractive index change in the core 12 of the optical fibre 14. Rather, the wavelength λ₁ and λ₂ are chosen such that where the interference pattern 10 overlaps with the beam 20, a refractive index change is induced in the core 12 via a two-photon process.

It is noted here that the beam 20 will not change the interference pattern 10 formed from the beam 18, as the two beams 20, 18 are incoherent.

In FIG. 2 two different excitation pathways of preferred embodiments to induce a refractive index change are shown. As illustrated in FIG. 2(a), one pathway involves a two-photon absorption mediated by a virtual energy level 34. Alternatively, a two-step one-photon absorption sequence mediated by an intermediate real energy level 36 may be used. In this approach, the additional energy level 36 can be made available for example by doping the material. Eg. Germano-silicate glass could be doped with a species of lanthanide ion.

It is noted that the rate of absorption via a real level (FIG. 2b) is orders of magnitude greater than the rate of absorption via a virtual level (FIG. 2a). This is because the activation energy required for the excitation from the lower level 30 to the band of excited states 32 can be reached by the sequential absorption of single photons via the real energy level 36, rather than the less likely simultaneous absorption of two photons.

To ensure that the two-photon processes cannot be induced through a single wavelength radiation, the energy levels 34 and 36 are not located at the mid point between the lower level 30 and the upper level 32. If the intermediate energy level was located at the mid point, the excitation could occur through two-photon processes associated with a single wavelength.

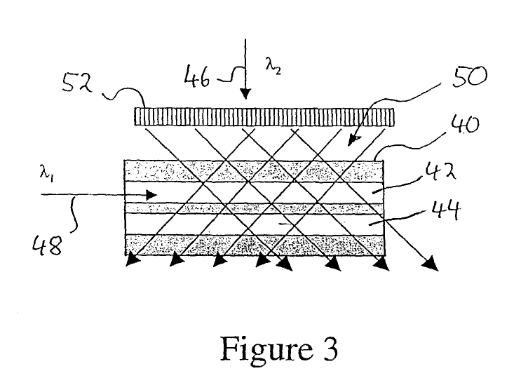

Turning now to FIG. 3, the method described above with reference to FIG. 1 may also be utilised to produce more complex devices, eg. device structures in a twin core optical fibre 40. In the past, the close proximity of the cores 42, 44 of the twin core fibre 40 made it necessary that only one of the cores 42, 44 was made photosensitive if eg. a grating was not to be written in the other core. This was due to the passing through of most of the radiation for inducing the refractive index changes in the one core through to the other core.

In an embodiment of the present invention, both cores 42, 44 of the twin core optical fibre 40 can be photosensitive, as the refractive index changes will only occur in areas of the cores 42, 44 in which the radiation of the two beams 46, 48 of suitable-wavelengths λ₂, λ₁, respectively, overlaps. As illustrated in FIG. 3, under the conditions shown in that Figure a grating structure corresponding to the interference pattern 50 set up from the beam 46 through a phase mask 52 will only be written in the upper core 42 of the twin core optical fibre 40, in which the second beam 48 is launched.

For the writing of a structure into the lower core 44 of the twin core optical fibre, the beam 48 is launched into that core 44, and the refractive index changes are then induced again where the beam 48 overlaps with the interference pattern 50. It will be appreciated that the interference pattern 50 can be varied between the writing of structures in the upper and lower cores 42, 44 of the twin core optical fibre 40, respectively, thus enabling fabrication of different gratings in the respective cores 42, 44.

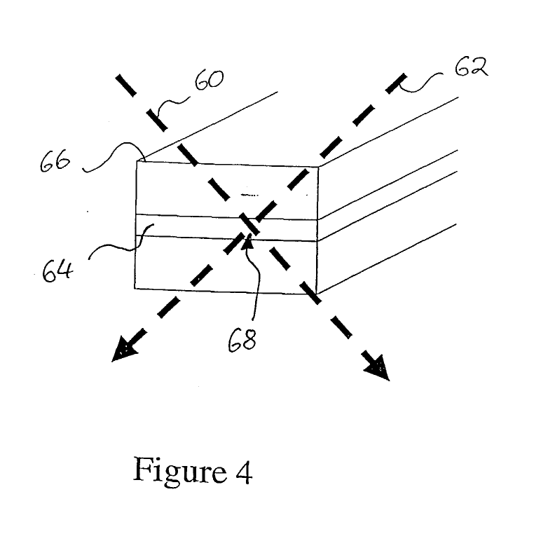

In FIG. 4, in an alternative embodiment, two beams 60, 62 are aligned such that their paths cross each other within a photosensitive planar waveguide 64 of a planar optical device 66. By suitable selection of the respective wavelengths of the beams 62 and 60, the desired change is induced in the planar waveguide 64 at the region 68 where the beams 62, 60 overlap. It will be appreciated that by appropriate scanning of the beams 62 and 60, various structures can be written into the planar waveguide 64, wherein the induced change is limited to the (moving) region 68 where the beams 62, 60 overlap. Again, the selection of a suitable pair of wavelengths for the respective beams 62, 60 ensures that adjacent photosensitive regions of the planar device structure 66 are not affected by the writing process.

In the following, aspects of identifying suitable wavelength pairs will be described with reference to germanium-doped silica glass.

The three absorption energy bands considered for Ge/silica are at 185, 244 and 325 nm. It appears to be most practical to attempt to reach the 325 nm band. If one attempts to reach the higher energy bands, the two wavelengths are either too similar (which could cause multiple absorption of the same wavelength), or one-of the two wavelengths is too close to 325 nm which could directly excite that band.

There are several possible wavelength pairs for 2-photon excitation (compare FIG. 2(a)) of the 325 nm band. As 2-photon absorption for a single wavelength does not occur above 550 nm in germanosilicate optical fibre, it would be advantageous to use a wavelength longer than this. The yellow 580 nm line from a copper vapour laser and the 740 nm output from a laser diode or titanium:sapphire laser are preferable. These sources would be readily available to us at power levels that exceed requirements. The absence of any strong absorption around the 200 or 400 nm suggests that the wavelength pair 400 and 1700 nm may also be appropriate, although procuring the appropriate laser sources may be problematic.

For the 2-step method (compare FIG. 2(b)), two possible combinations of lanthanides and wavelength pairs are (1) ytterbium with 975 nm and 488 nm; and (2) neodymium with 740 nm and 580 nm. In case (1), the ytterbium ²F_{5/2}→²F_{7/2} absorption is peaked at 975 nm, and a subsequent absorption of a 488 nm photon should allow energy transfer to the 325 nm band. 975 nm can be obtained from a titanium:sapphire laser or a diode laser, while 488 nm can be obtained from an argon ion laser. Ytterbium is a preferred choice because it has no absorption above ˜1.1 μm, leaving the wavelength region beyond this-free for the final application. In case (2), the neodymium ⁴I_{9/2}→²G_{7/2} absorption is peaked at 580 nm (copper vapour laser), and a subsequent absorption of a 740 nm photon (titanium sapphire or diode laser) will reach the 325 nm band. All of the mentioned laser sources are practical and are readily available. Table 1 summarises the material and wavelength options available.

TABLE 1
Material and wavelength pair options.

| Material | λ₁ (source) | λ₂ (source) |
|---|---|---|
| Ge:Silica | 580 nm (Cu:Vapour) | 740 nm (Diode or |
| | | Ti:Sapph.) |
| Ge:Silica | 400 nm (Ar ion pumped Dye | 1730 nm (Raman |
| | Laser) | Laser) |
| Nd,Ge: | 580 nm (Cu:Vapour) | 740 nm (Diode or |
| Silica | | Ti:Sapph) |
| Yb,Ge: | 488 nm (Ar Ion) | 975 nm (Diode or |
| Silica | | Ti:Sapph) |

The doping of the glasses with lanthanide ions is preferred if one wishes to make active optical components. This is because lanthanide doped glasses are well known laser materials. This technology can be used to build simple, compact, efficient and high-power (>100 W) fibre lasers.

The present invention has applications in the fabrication of novel active devices using Yb,Ge:Silica because it provides a direct route of writing complex phase objects in the gain region. Similar possibilities exist for Nd,Ge:Silica.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication, the word “comprising” is used in the sense of “including”, i.e. the features specified may be associated with further features in various embodiments of the invention.

We claim:

1. A method of inducing a change of refractive index in a photosensitive material comprising:
simultaneously exposing a region of the material to first and second radiations having first and second wavelengths respectively and being selected to, in combination, induce the change in refractive index in the region;
wherein the first and second wavelengths differ from each other, and each of the first and second wavelengths alone being substantially ineffective in inducing a refractive index change in the region.

2. A method as claimed in claim 1, wherein the region comprises a light-guiding region of a waveguide formed in the photosensitive material, and a first beam of the first radiation is coupled into and guided along the waveguide; and
a second beam of the second radiation is used to illuminate the light-guiding region from outside the waveguide.

3. A method as claimed in claim 2 wherein only the first radiation is propagated along the light-guiding region.

4. A method as claimed in any one of the preceding claims wherein the photosensitive material includes an outer plastics coating and the photosensitive material is exposed to the second radiation through the outer plastics coating, the wavelength of the second radiation being selected to pass through the plastics coating substantially without absorption.

5. A method as claimed in any one of claims 2-4, wherein the waveguide comprises an optical fibre.

6. A method as claimed in claim 5, wherein the optical fibre comprises a multiple-core optical fibre.

7. A method as claimed in claim 6, wherein the light-guiding region comprises a first core of the multiple fibre, and the first beam is coupled into and guided along the first core so as to induce the refractive index change in the first core only.

8. A method as claimed in any one of the preceding claims, wherein each of the first and second wavelengths is selected to be ineffective alone in inducing a further change in the photosensitive material.

9. A method as claimed in any one of the preceding claims, wherein the first and second radiations are provided from the same source.

10. A method as claimed in any one of the preceding claims, wherein the method further comprises the steps of setting up an interference pattern with a first beam of the first radiation in the material, and exposing the material to a second beam of the second radiation so as to induce the refractive index change in the material where the interference pattern and the second beam overlap.

11. A method as claimed in claim 10 wherein at least one of the first and second beams has a spatially-varying profile.

12. A method as claimed in claim 11, wherein the method further comprises utilising a chosen intensity profile of the second beam to control the overlapping of the second beam with the interference pattern.

13. A method as claimed in any one of the preceding claims, wherein at least one of the first and second wavelengths is chosen from a range of visible wavelengths.

14. A method as claimed in any one of the preceding claims, wherein the photosensitive material comprises germanium-doped glass, and wherein combined photon energies of the first and second radiations are selected to excite a 185 nm absorption band in the germanium-doped glass.

15. A method as claimed in any one of claims 1 to 13, wherein the photosensitive material comprises germanium-doped glass, and wherein combined photon energies of the first and second radiations are selected to excite a 244 nm absorption band in the germanium-doped glass.

16. A method as claimed in any one of claims 1 to 13, wherein the photosensitive material comprises germanium-doped glass, and wherein combined photon energies of the first and second radiations are selected to excite a 325 nm absorption band in the germanium-doped glass.

17. A method as claimed in any one of the preceding claims, wherein the step of inducing the refractive index change in the region comprises absorbing the first and second radiations mediated by a real transition level of the photosensitive material.

18. A method as claimed in claim 17, wherein the photosensitive material comprises glass, and the real transition level is provided by doping the glass with lanthanide ions.

21. An optical device incorporating a photosensitive material in which a refractive change has been induced in the photosensitive material using a method in accordance with any one of the preceding claims.

22. A method of inducing a change of refractive index in a photosensitive material substantially as herein described with reference to the accompanying drawings.

23. An optical device substantially as herein described with reference to the accompanying drawings.
